(19) United States
(12) Patent Application Publication
(10) Pub. No.: US 2014/0321924 A1
(43) Pub. Date: Oct. 30, 2014

(54) DETACHABLE BOLT

(71) Applicant: Ku-Hsi Hu, Taipei (TW)

(72) Inventor: Ku-Hsi Hu, Taipei (TW)

(21) Appl. No.: 13/869,989

(22) Filed: Apr. 25, 2013

(51) Int. Cl. E02D 29/02; E02D 5/76; F16B 33/02; E21D 20/00

(52) U.S. Cl. CPC E02D 29/0233; E21D 20/00; E02D 5/765; F16B 33/02
USPC 405/259.5; 411/411

(57) ABSTRACT

A detachable bolt includes a bolt body being a round bar and having an inner end and an outer end; a periphery of the inner end being formed with at least one screw section with threads thereon and at least one circular section; each circular section having a smooth surface with a plurality of protrusions. The outer end of the bolt may be a structure like that of the inner end, or may have threads thereon, or may be smooth, or may be sleeved by a sleeve. In detaching process, other than the gluing material in the hole will break, the object to be retained and the retaining wall will not be destroyed. The bolt body can be removed from the object and the wall easily without great forces applied thereto. Furthermore, the wall and the object to be retained can be restored to the original outlook easily.

### FIELD OF THE INVENTION

The present invention relates to bolts and in particular to a detachable bolt and a combing structure thereof.

### BACKGROUND OF THE INVENTION

There are many different kinds of bolts. The general used bolts are chemical bolts, safety metal bolts, safety plastic bolts, etc., which are used for combinations and retaining. However, the prior art bolts retain an object to a retaining wall eternally. If it is desired to detach the object from the retaining wall, the bolt or the retaining wall will be destroyed by strong forces, even the object retaining to the wall is also destroyed.

Therefore, if there is an eager demand for a novel bolt. When the bolt is detached from the retaining wall, the wall does not be destroyed so that the wall has a beautiful outlook. The bolt body is reusable. Furthermore, the detaching work is performed easily and quickly.

### SUMMARY OF THE INVENTION

Accordingly, the object of the present invention is to resolve the problems of the prior art, and thus the present invention provides a detachable bolt and a combining structure thereof, wherein in detaching process, other than the gluing material in the hole will break, the object to be retained and the retaining wall will not be destroyed. The bolt can be removed from the object and the wall easily without great forces applied thereto. Furthermore, the wall and the object to be retained can be restored to the original outlook easily.

To achieve above object, the present invention provides a detachable bolt, comprising: a bolt body being a round bar and having an inner end and an outer end; a periphery of the inner end being formed with at least one screw section with threads thereon and at least one circular section which is alternatively arranged with the screw sections; each circular section having a smooth surface with a plurality of protrusions.

A periphery of the outer end is formed with at least one screw section with threads thereon and at least one circular section which is alternatively arranged with the screw sections; each circular section of the outer end has a smooth surface with a plurality of protrusions thereon. Or a periphery of the outer end is threaded. Or a periphery of the outer end is a smooth surface. And furthermore, a sleeve sleeves around the outer end.

### BRIEF DESCRIPTION OF THE DRAWINGS

FIG. 1A is a perspective view of the present invention.

FIG. 1B is a lateral view showing the first embodiment of the present invention.

FIG. 2A is a lateral view showing that the bolt body of the present invention is locked to a retaining surface.

FIG. 2B is a front view of the present invention.

FIG. 2C is a further lateral view showing that that another end of the bolt body shown in FIG. 2A is further locked to an object.

FIG. 3 is a schematic view showing the second embodiment of the present invention.

FIG. 4 is a schematic view showing the third embodiment of the present invention.

FIG. 5 is a schematic view showing an application for the third embodiment.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

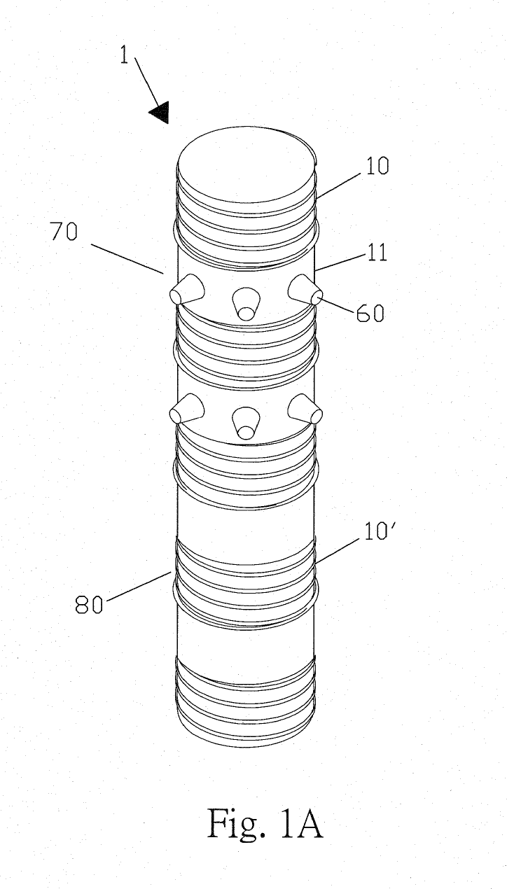

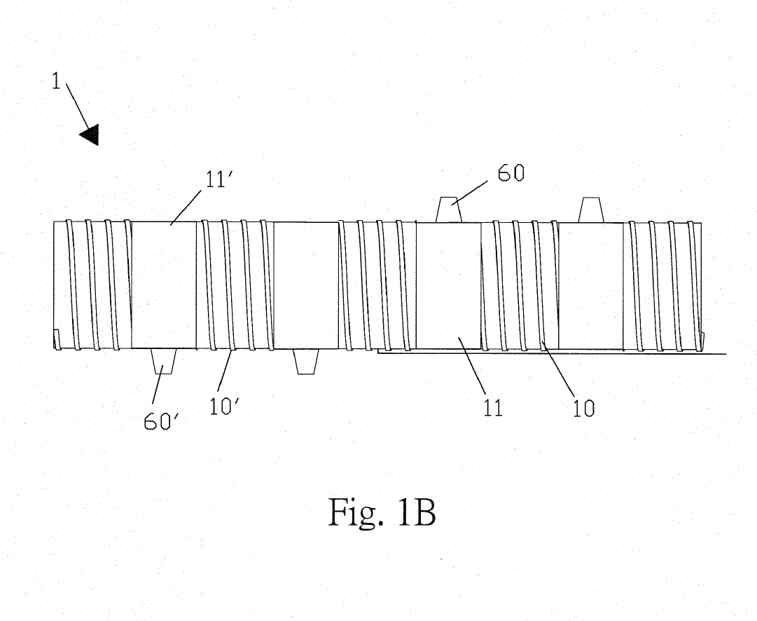

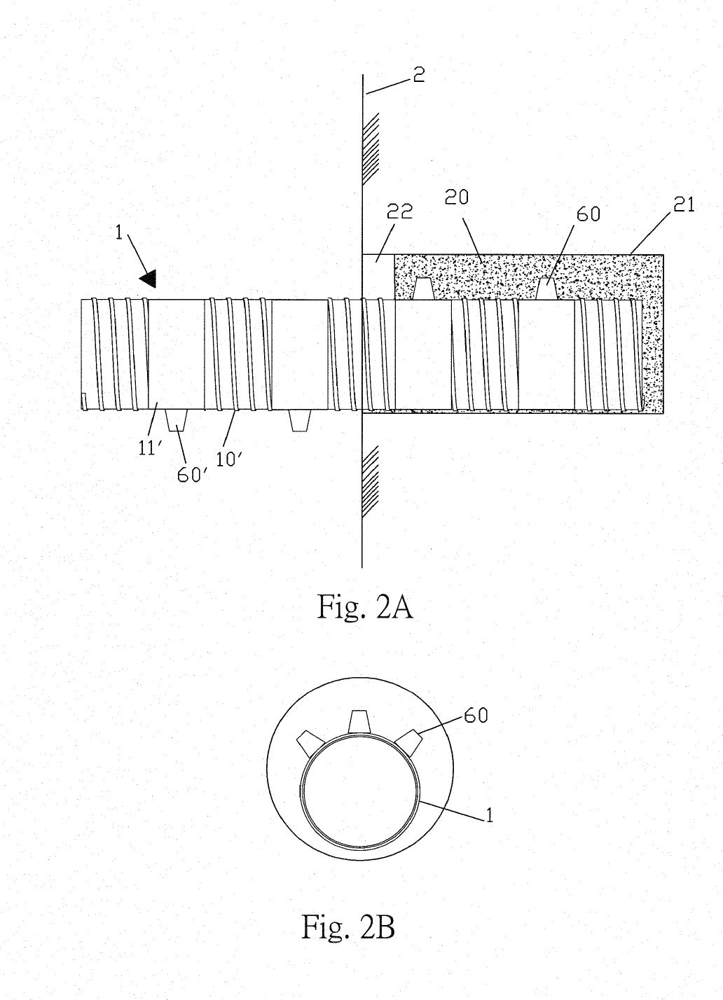

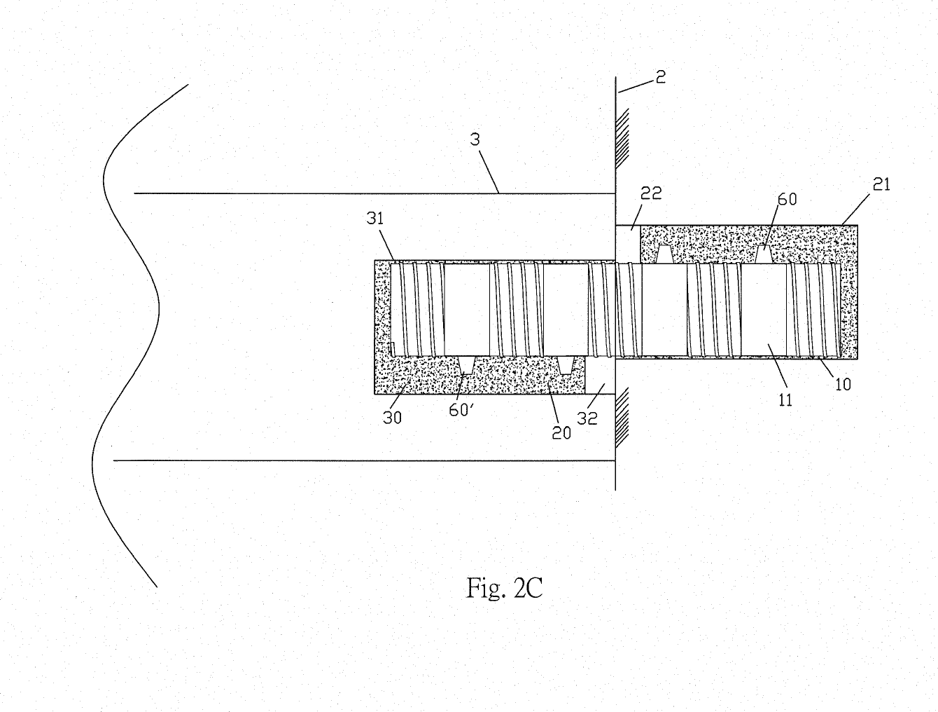

With reference to FIGS. 1A, 1B, 2A, 2B and 2C, the structure of the present invention is illustrated. The present invention has the following elements.

As a illustrated in FIG. 1A, a bolt body 1 is a round bar having an inner end 70 and an outer end 80. A periphery of the inner end 70 is formed with at least one screw section 10 with threads thereon and at least one circular section 11 which is alternatively arranged with the screw sections 10. Each circular section 11 has a smooth surface with a plurality of protrusions 60.

In the first embodiment of the present invention, referring to FIG. 1B, a periphery of the outer end 80 is formed with at least one screw section 10′ with threads thereon and at least one circular section 11′ which is alternatively arranged with the screw sections 10′. Each circular section 11′ has a smooth surface with a plurality of protrusions 60′.

Preferably, there are a plurality of screw sections 10, 10′ which are equally-spaced arranged thereon and there are a plurality of circular sections 11, 11′ which are equally-spaced arranged thereon. Moreover, at least two screw sections 10, 10′ are arranged and at least two circular sections 11, 11′ are arranged. Furthermore, the protrusions 60, 60′ are arranged on an arc surface not over 180 degrees.

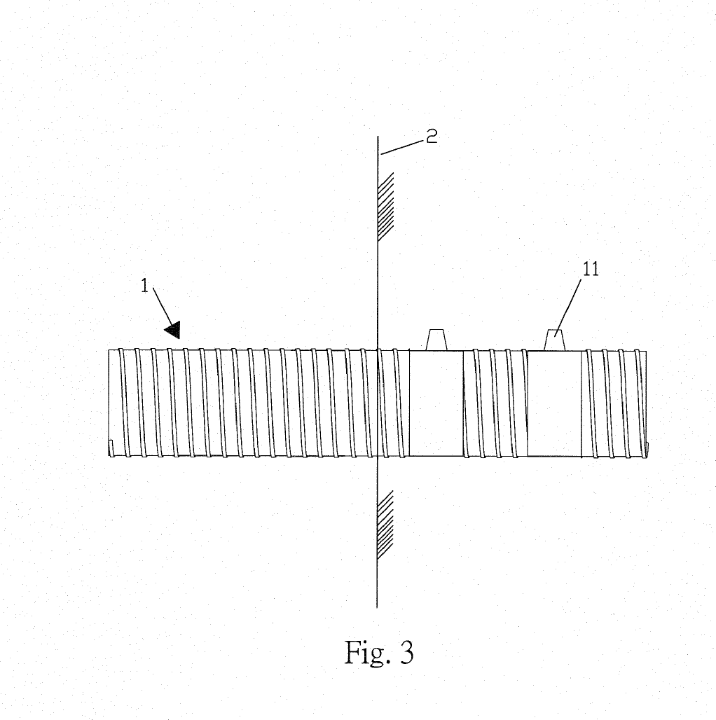

With reference to FIG. 3, the second embodiment of the present invention is illustrated. This embodiment is similar to the former one. Thus those in FIG. 3 with numerals identical to those illustrated in FIG. 2 are not further described herein. Only those different from the former embodiment are described herein. In this embodiment, a periphery of the outer end is threaded.

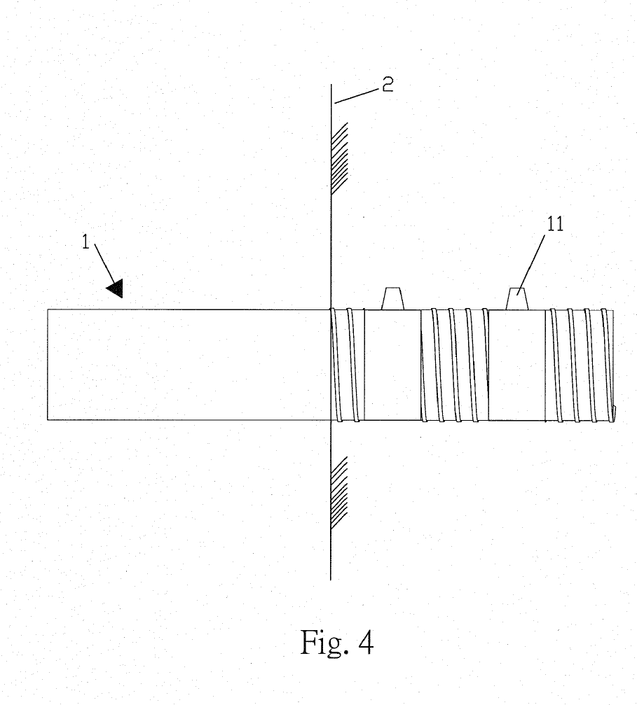

With reference to FIG. 4, the third embodiment of the present invention is illustrated. This embodiment is similar to the former one. Thus those in FIG. 3 with numerals identical to those illustrated in FIG. 2 are not further described herein. Only those different from the former embodiment are described herein. In this embodiment, a periphery of the outer end is a smooth surface.

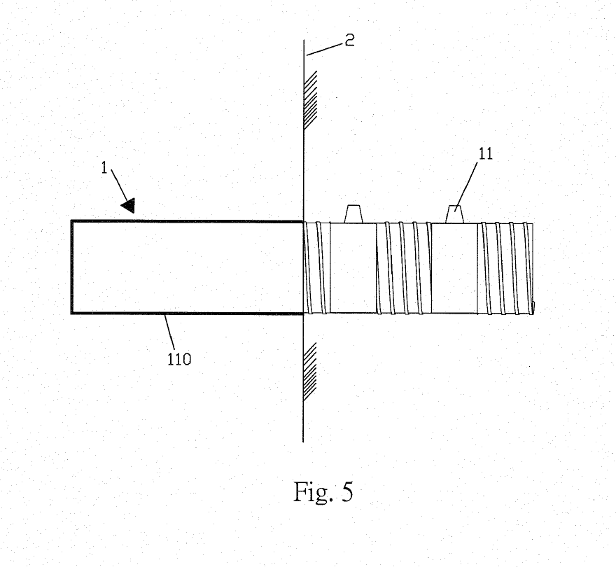

With reference to FIG. 5, it is illustrated that a cover 1 10 further covers the smooth outer end illustrated in FIG. 4.

In working, a retaining wall 2 is bored with a hole 21 which has a diameter greater than that of the bolt body 1. The inner end of the bolt body 1 is located within the hole 21 of the retaining wall 2. A gluing layer 20 is formed in the hole 21 between an inner wall of the hole 21 and an outer periphery of the inner end of the bolt body 1. A breaking space 22 is formed in the hole 21 not filled by the gluing layer 20. The outer end 80 of the bolt body 1 exposes out of the hole 21. In installation, the protrusions 60 of the inner end 70 of the bolt body 1 are located at the upper side of the bolt body 1 and thus the lower side of the inner end of the bolt body 1 will near the inner wall of the hole 21. Most of the gluing material of the gluing layer 20 is at the upper side of the inner end of the bolt body 1. Preferably, the breaking space 22 is near the outer side of the hole 21 of the bolt body 1.

The gluing material of the gluing layer 20 is cements or slurry which provides proper construction in knocking. The ratio of the cements or slurry to water is adjustable as desired.

For the structure illustrated in FIG. 1, an object 3 to be retained to the retaining wall 1 is bored with a hole 31. A diameter of the hole 31 of the object 3 is greater than that of the outer end 80 of the bolt body 1. The outer end of the bolt body 1 is located within the hole 31 of the object 3. A gluing layer 30 is formed in the hole 31 of the object 3 between an inner wall of the hole 31 of the object 3 and an outer periphery of the outer end 80 of the bolt body 1. A breaking space 32 is formed in the hole 31 not filled by the gluing layer 30. In installation, the protrusions 70 of the outer end of the bolt body 1 are located at the lower side of the bolt body 1 and thus the lower side of the inner end of the bolt body 1 will near the inner wall of the hole 31. Most of the gluing material of the gluing layer 30 is at the lower side of the inner end of the bolt body 1. Preferably, the breaking space 32 of the hole 31 of the object 3 is near the outer side of the hole 31.

If it is desired to detach the object 3 from the retaining wall 2, it is only needed to knock the object 3 so that the force will respond to the protrusions 60 and 60′. As a result, the gluing layers 20 and 30 will break. The breaking spaces 22, 32 provide spaces for containing the breaking gluing material. As a result, the bolt body 1 can be taken out from the holes 21, 31 easily.

As mentioned above, the gluing material may be cement or cements or slurry. Since the force to break the gluing material is related to the gluing material, a ratio of the cement to water is adjustable based on the demand in detaching operation.

Advantages of the present invention are that in detaching process, other than the gluing material in the hole will break, the object to be retained and the retaining wall will not be destroyed. The bolt body can be removed from the object and the wall easily without great forces applied thereto. Furthermore, the wall and the object to be retained can be restored to the original outlook easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A detachable bolt, comprising:
a bolt body being a round bar and having an inner end and an outer end; a periphery of the inner end being formed with at least one screw section with threads thereon and at least one circular section which is alternatively arranged with the screw sections; each circular section having a smooth surface with a plurality of protrusions.

2. The detachable bolt as claimed in claim 1, wherein a periphery of the outer end is formed with at least one screw section with threads thereon and at least one circular section which is alternatively arranged with the screw sections of the outer end; each circular section of the outer end has a smooth surface with a plurality of protrusions thereon.

3. The detachable bolt as claimed in claim 1, wherein a periphery of the outer end is threaded.

4. The detachable bolt as claimed in claim 1, wherein a periphery of the outer end is a smooth surface.

5. The detachable bolt as claimed in claim 4, wherein a sleeve sleeves around the outer end.

6. The detachable bolt as claimed in claim 1, wherein there are at least two circular sections in the inner end.

7. The detachable bolt as claimed in claim 2, wherein there are at least two circular sections in the outer end.

8. The detachable bolt as claimed in claim 1, wherein the protrusions of the inner end are arranged on an arc surface not over 180 degrees.

9. The detachable bolt as claimed in claim 2, wherein the protrusions of the outer end are arranged on an arc surface not over 180 degrees; and
the protrusions of the inner end are located at an upper surface of the inner end and the protrusions of the outer end are located at a lower surface of the inner end

10. A combining structure with a detachable bolt and a retaining wall, comprising:
a bolt body being a round bar and having an inner end and an outer end; a periphery of the inner end being formed with at least one screw section with threads thereon and at least one circular section which is alternatively arranged with the screw sections; each circular section having a smooth surface with a plurality of protrusions;
a retaining wall having a hole which has a diameter greater than that of the bolt body; the inner end of the bolt body being located within the hole of the retaining wall;
a gluing layer being formed in the hole between an inner wall of the hole and an outer periphery of the inner end of the bolt body;
a breaking space being formed in the hole not filled by the gluing layer and the inner end of the bolt body;
wherein the outer end of the bolt body exposes out of the hole; the protrusions of the inner end of the bolt body are located at the upper side of the bolt body and thus a lower side of the inner end of the bolt body is near an inner wall of the hole; most of the gluing material of the gluing layer being at an upper side of the inner end of the bolt body.

11. The combining structure as claimed in claim 11, wherein the breaking space is near an outer side of the hole of the bolt body.

12. The combining structure as claimed in claim 1, further comprising:
an object to be retained to the retaining wall being bored with a hole; a diameter of the hole of the object being greater than that of the outer end of the bolt body; the outer end of the bolt body being located within the hole of the object;
a second gluing layer being formed in the hole of the object between an inner wall of the hole of the object and an outer periphery of the outer end of the bolt body; a breaking space being formed in the hole not filled by the gluing layer; the protrusions of the outer end of the bolt body being located at the lower side of the bolt body and thus the lower side of the inner end of the bolt body being near the inner wall of the hole; most of the gluing material of the gluing layer being at the lower side of the inner end of the bolt body.

13. The combining structure as claimed in claim 12, wherein the breaking space of the hole of the object is near an outer side of the hole of the object.

14. The combining structure as claimed in claim 10, wherein the protrusions of the inner end are arranged on an arc surface not over 180 degrees.

15. The combining structure as claimed in claim 12, wherein the protrusions of the outer end are arranged on an arc surface not over 180 degrees; and the protrusions of the inner end are located at an upper surface of the inner end and the protrusions of the outer end are located at a lower surface of the inner end
